(19) United States
(12) Patent Application Publication
(10) Pub. No.: US 2004/0246504 A1
(43) Pub. Date: Dec. 9, 2004

(54) Printing device, printing job transmission device, printing method, printing job transmission method, printing program, printing job transmission program, and computer-readable recording medium for recording said programs

(75) Inventor: Toshiyuki Mitsubori, Kawasaki-shi (JP)

Correspondence Address: BURNS DOANE SWECKER & MATHIS L L P, POST OFFICE BOX 1404, ALEXANDRIA, VA, 22313-1404, US

(73) Assignee: KONICA MINOLTA BUSINESS TECHNOLOGIES, INC.

(21) Appl. No.: 10/705,844

(22) Filed: Nov. 13, 2003

(30) Foreign Application Priority Data
Jun. 6, 2003 (JP) 2003-162930

(51) Int. Cl. G06F 15/00

(52) U.S. Cl. 358/1.1; 358/1.15

(57) ABSTRACT

Upon receiving a print job, the printer analyzes the header part to determine whether it is a default setup printing; if it is a default setup printing, it obtains the default setup from the command part and updates the default setup. It then prints out the contents of the updated default setup and also prints the test printing data included in the print job according to the updated default setup.

The printing system according to this invention makes it possible to execute default setup of the printing device and test printing simultaneously with a single printing job transmission from a printing job transmission device.

This application is based on Japanese Patent Application No. 2003-162930 filed on Jun. 6, 2003, the contents of which are hereby incorporated by reference.

### BACKGROUND OF THE INVENTION

1. Field of the Invention

The invention relates to a printing system including a printing job transmission device and a printing device. More specifically, it relates to a printing system capable of executing default setup operations and test printing for a printing device, in accordance with a transmission of a printing job from a printing job transmission device.

2. Description of Related Art

A printing device such as a printer is normally subjected to setup of default values and test printing during inspections at the time of shipment from the factory. Default setup is conducted by setup operations by means of a dedicated application program of a personal computer, etc. or the operation panel of a printer, while test printing is conducted by transmitting test printing data from a device such as a personal computer.

In case when the printer is supplied to OEM accounts or exported to a plurality of countries, it is necessary to set up defaults differently depending on each OEM and destination country. Therefore, a plurality of default setup scan exist for a particular printer model, which affects the work efficiency, and may cause problems such as a mistake of default setup due to human errors.

On the other hand, a printer has been known (JP-6-247012A), wherein, if the control code of the printing data included in the received printing job is not identical to the default setup, it is automatically switched to the printing control program suitable for said control code to conduct the printing process, and reverts back to the printing control program of the default setup after the process. However, no printing system has been known for simultaneously executing default setup for varieties of printer hardware and test printing by means of transmitting a single printing job from a personal computer, etc.

### SUMMARY OF THE INVENTION

The present invention was made in order to solve the abovementioned problem of the prior art and is intended to provide a printing system that is capable of executing default setup for a printer and test printing simultaneously by transmitting a single instruction of the printing job from a printing job transmission device.

Another object of the present invention is to provide a printing system that is capable of default setup for printer and confirming the contents of the default setup simultaneously by means of transmitting a single instruction of the printing job from a printing job transmission device.

Said objective of the present invention can be accomplished by the following means:

(1) A printing device comprising: a printing job receiving unit for receiving a printing job; a command analyzing unit for analyzing a command included in said printing job; a default setup modifying unit for modifying a default setup based on a default setup modifying command when said command is said default setup modifying command; and a printing unit for printing data to be printed included in said printing job.

(2) A printing job transmission device comprising:

a default setup inputting unit for inputting a default setup for a printing device; a printing job preparation unit for preparing a printing job including a default setup modifying command for modifying the default setup of said printing device to a default setup entered by said default setup input unit; and a printing job transmission unit for transmitting said printing job to said printing device.

(3) A printing system comprising a printing device and a printing job transmission device, which are connected to be able to communicate with each other; wherein, said printing job transmission device comprising: a default setup inputting unit for inputting a default setup for said printing device; a printing job preparation unit for preparing a printing job including a default setup modifying command for modifying the default setup of said printing device to a default setup entered by said default setup input unit; and a printing job transmission unit for transmitting said printing job to said printing device; and said printing device comprising: a printing job receiving unit for receiving a printing job; a command analyzing unit for analyzing a command included in said printing job; a default setup modifying unit for modifying a default setup based on a default setup modifying command when said command is said default setup modifying command; and a printing unit for printing data to be printed included in said printing job.

(4) A printing method comprising: a printing job receiving step of receiving a printing job; a command analyzing step of analyzing a command included in said printing job; a default setup modifying step of modifying a default setup based on a default setup modifying command when said command is said default setup modifying command; and a printing step of printing data to be printed included in said printing job.

(5) A printing job transmission method comprising: a default setup inputting step of inputting a default setup for a printing device; a printing job preparation step of preparing a printing job including a default setup modifying command for modifying the default setup of said printing device to a default setup entered by said default setup input step; and a printing job transmission step of transmitting said printing job to said printing device.

(6) A printing program for causing a printing device to execute: a printing job receiving step of receiving a printing job; a command analyzing step of analyzing a command included in said printing job; a default setup modifying step of modifying a default setup based on a default setup modifying command when said command is said default setup modifying command; and a printing step of printing data to be printed included in said printing job..

(7) A computer-readable medium storing the printing program described in (6).

(8) A printing job transmission program for causing a printing job transmission device to execute: a default setup inputting step of inputting a default setup for a printing device; a printing job preparation step of preparing a printing job including a default setup modifying command for modifying the default setup of said printing device to a default setup entered by said default setup input step; and a printing job transmission step of transmitting said printing job to said printing device.

(9) A computer-readable medium storing the printing job transmission program described in (8).

### BRIEF DESCRIPTION OF THE DRAWINGS

FIG. 1 is a block diagram showing the overall constitution of a printing system wherein a printing data transmission device and a printing device according to an embodiment of the present invention is applied.

FIG. 2 is a block diagram showing the constitution of personal computer 1 shown in FIG. 1.

FIG. 3 is a block diagram showing the constitution of printer 2 shown in FIG. 1.

FIG. 4 is a flow chart showing the procedure of default setup printing job transmission process of personal computer 1.

FIG. 5 is a conceptual drawing of an example of default setup printing job prepared by personal computer 1.

FIG. 6 is a conceptual drawing showing an example of the constitution of command 44 included in default setup printing job 4 shown in FIG. 5.

FIG. 7 is a conceptual drawing of an example of default setup table in which printer default setup modification commands contained in personal computer 1 are registered.

FIG. 8 is a flow chart showing the procedure of default setup printing job process of printer 2.

FIG. 9 shows an example of status sheet printed with the contents of updated default setup to be printed by printer 2.

### DESCRIPTION OF THE PREFERRED EMBODIMENTS

The preferred embodiments of the invention will be described in detail below with reference to the accompanying drawings.

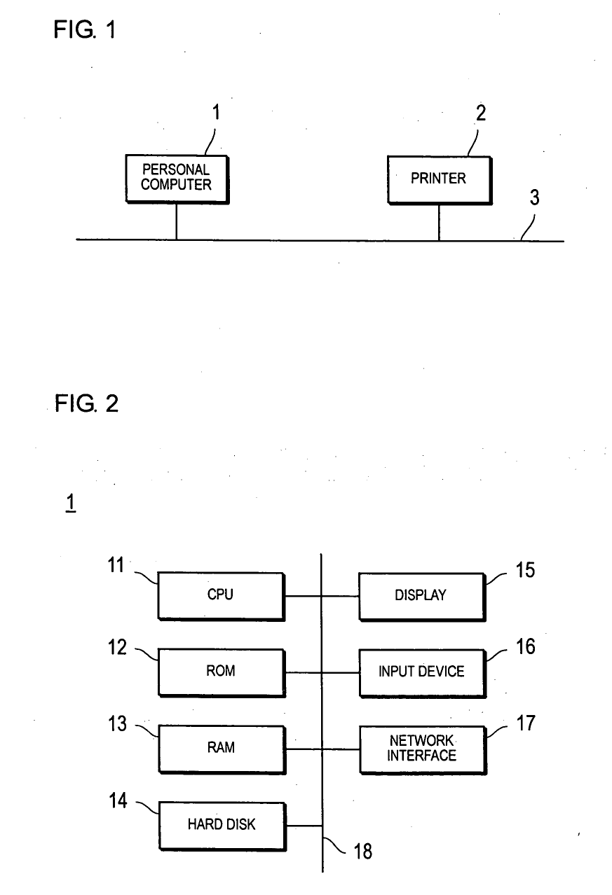

FIG. 1 is a block diagram showing the overall constitution of a printing system wherein a printing data transmission device and a printing device according to a first embodiment of the present invention is applied. As shown in FIG. 1, the printing system according to this embodiment is equipped with a personal computer 1 as a printing data transmission device and a printer 2 as a printing device, which are connected via a network 3 to communicate with each other. The types and the number of equipment to be connected to network 3 are not limited to those shown in FIG. 1. Also, personal computer 1 and printer 2 can be connected directly (local connection) without recourse to network 3.

Next, the constitution of each device will be described and it is noted here that each of those devices can include constituents other than those to be described later or can include only a part of the constituents to be described later. Also, the description of a function common to multiple devices will be made only once when it appears first time and will not be repeated afterwards in order to avoid duplicate descriptions.

FIG. 2 is a block diagram showing the constitution of personal computer 1 according to the present embodiment. As shown in FIG. 2, personal computer 1 contains a CPU 11, a ROM 12, a RMA 13, a hard disk 14, a display 15, an input device 16, and a network interface 17, all of which are interconnected by a bus 18 for exchanging signals.

CPU 11 controls various parts indicated above and executes various arithmetic processes according to a program. ROM 12 stores programs and parameters for controlling basic operations of personal computer 1. RAM 13 stores programs and data temporarily as a working area. Hard disk 14 stores an OS (operating system, or basic software program) as well as programs and parameters for controlling the specified operations of personal computer 1 to be described later, and various image data to be printed and others.

Display 15 displays various kinds of information. Input device 16 consists of a keyboard, a mouse and others, and is used for making various kinds of inputs.

Network interface 17 is an interface for allowing the system to access a network and communicate with other equipment on the network.

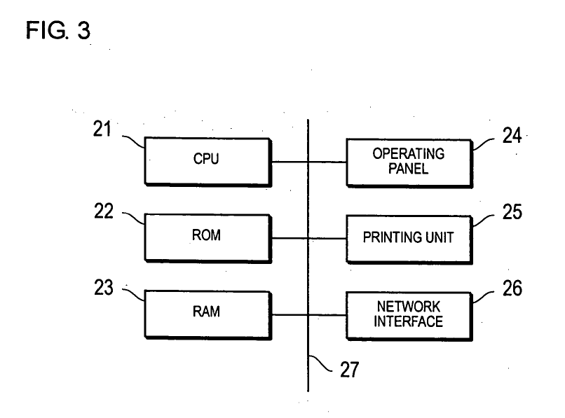

FIG. 3 is a block diagram showing the constitution of printer 2 according to the present embodiment. As shown in FIG. 2, printer 2 contains a CPU 21, a ROM 22, a RAM 23, an operating panel 24, a printing unit 25, and a network interface 26, all of which are interconnected by a bus 27 for exchanging signals.

Operating panel 24 consists of a display panel, fixed keys, indicator lamps and others used for various inputting and displaying purposes.

Printing unit 25 prints the printing data that are developed into bit map data in accordance with the setup condition.

Network 3 can be a LAN connecting computers and network equipment according to standards such as Ethernet®, Token Ring, and FDDI, or a WAN that consists of several LANs connected by a dedicated line.

In the printing system according to the present embodiment, it is possible to use as the data communication protocol between personal computer 1 and printer 2 a specific protocol that is capable of bi-directional communications, can establish a session for each job, and is capable of transmitting an arbitrary portion of the data in a file, for example, Raw (TCP/IP 9100), LPR (Line Printer Remote), IPP (Internet Printing Protocol), etc. However, it is also possible to use a original protocol.

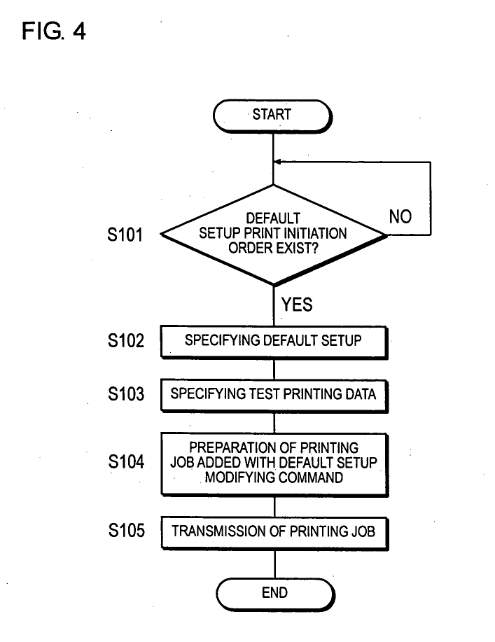

Next, the outline of the printing system according to this embodiment will be described below. FIG. 4 is a flow chart showing the procedure of default setup printing job transmission process of personal computer 1 according to the present embodiment. The algorithm indicated by the flowchart of FIG. 4 is stored as a control program on hard disk 14 of personal computer 1, read out on RAM 13, and is executed by CPU 11 when the operation starts.

In FIG. 4, personal computer 1 stands by first until it is ordered to start default setup printing (S101: No). The user enters the operation start order for the default setup printing, for example, by operating the mouse from the initial screen of the default setup printing shown on display 15, or by entering the command from the keyboard.

Upon receiving the default setup printing start order (S101: Yes), personal computer 1 accepts an input specifying the contents of the default setup to be set up on printer 2, and stores the setup in RAM 13 (S102). The user enters an input specifying the default setup, for example, by operating the mouse from the specifying screen of the default setup contents shown on display 15, or by entering the command from the keyboard. The contents of the default setup of the present embodiment will be described later.

Further, an input for specifying the test printing data to be printed by printer 2 is received and stored in RAM 13 (S103). The test printing data is an image data to be printed by printer 2 according to the default setup specified in step S102 for the purpose of confirmation printing. Test printing data is an image data consisting of characters, graphics, photographs, or a mixture of them, and is normally specified by the user from image data stored in a specified area of hard disk 14 by means of, for example, mouse operation from a specified screen of the test printing data shown in display 15, or by means of command input from the keyboard.

The default setup specifying process (S102) and the test printing data specifying process (S103) mentioned above can be executed in any order.

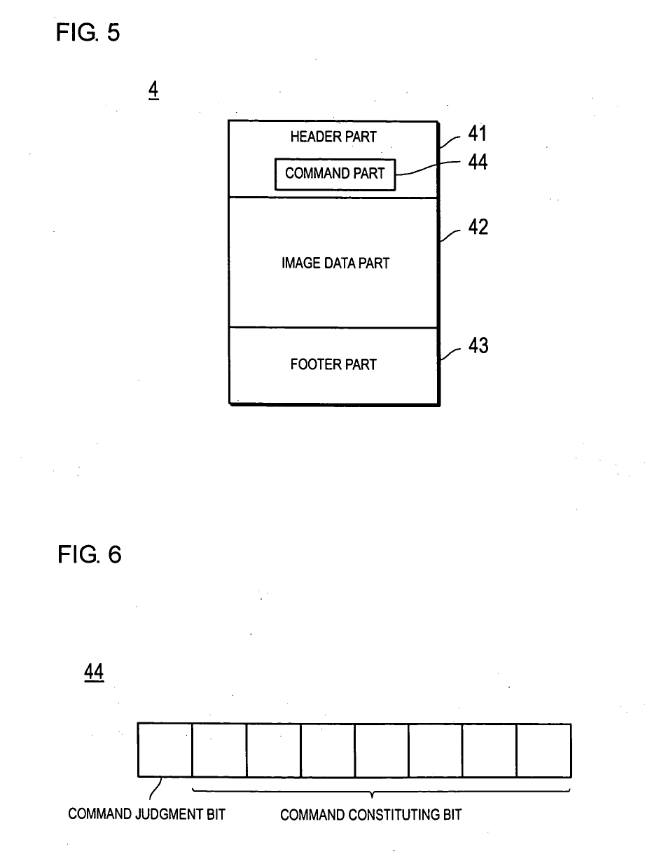

When the default setup specification and the test printing data specification are finished, a default setup printing job attached with a default setup modifying command is prepared and stored in RAM 13 (S104). FIG. 5 is a conceptual drawing of an example of default setup printing job prepared by personal computer 1. As shown in FIG. 5, default printing job 4 consists of a header part 41, an image data part 42, and a footer part 43. Header part 41 contains printing conditions for each job such as the image resolution, the paper size, the selection of color vs. monochromatic, and others, as well as a command part 44. Command part 44 includes a default setup modifying command for modifying the default setup of printer 2 to the default setup specified in step S102.

FIG. 6 is a conceptual drawing showing an example of the constitution of command 44 included in default setup printing job 4. As shown in FIG. 6, command part 44 consists of eight bits, the highest position bit being the command judgment bit and followed by seven bits that constitute a command. The command judgment bit is a bit that determines whether the command contained in command part 44 is valid; if the command judgment bit is “1,” the command is determined as valid and if the command judgment bit is “0,” it is determined invalid.

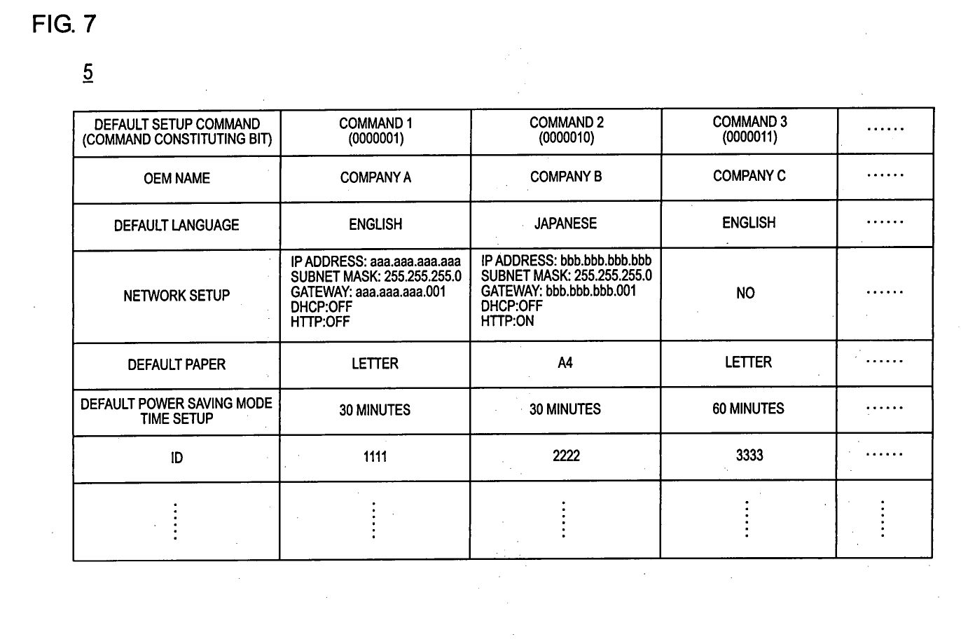

The command constituting bits here are the bits that constitute a default setup modifying command. Personal computer 1 stores a default setup table registered with default setup modifying command shown in FIG. 7 on hard disk 14. FIG. 7 shows that various combinations of default setups concerning various setup items concerning printer 2 such as OEM's name, default language, network setup, default paper size, time setup for default power saving mode, and identification are pre-registered in default setup table 5 in correspondence with the default setup modifying command. For example, if the default setup command is command 1, i.e., if the command constituting bits are “0000001,” the contents of the default setup include Company A as the OEM, English as the default language, and so on. In step S104, personal computer 1 retrieves default setup table 5 onto RAM 13, and writes the command constituting bits related to said default setup into command part 44 of header part 41 of default printing job 4 according to the contents of the default setup specified in the default setup specifying process (S102).

In step S104, personal computer 1 compresses the image data related to the test printing data specified in the test printing data specifying process (S103) to make it a part of image data part 42 of default setup printing job 4. When the printing job preparation process is completed, the default setup printing job thus prepared is transmitted to printer 2 via network interface 17 and network 3 (S105) to complete the default setup printing job transmission process.

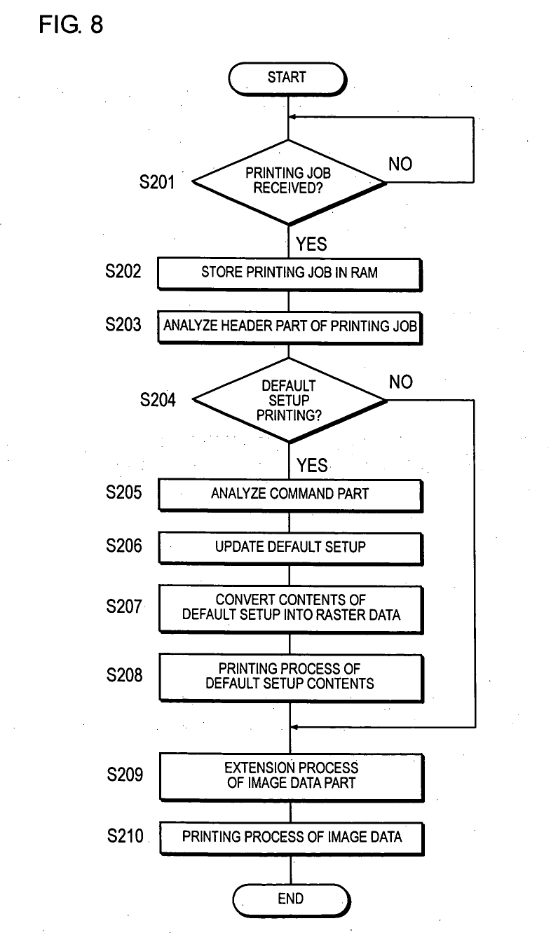

Next, let us describe the outline of the operation of printer 2 in the present embodiment. FIG. 8 is a flow chart showing the procedure of default setup printing job process of printer 2 in the present embodiment. The algorithm indicated by the flowchart of FIG. 8 is stored as a control. program on ROM 22 of printer 2, read out on RAM 23, and is executed by CPU 21 when the operation starts.

In FIG. 8, printer 2 stands by until a printing job is received from personal computer 1 (S201: No); when a printing job is received from personal computer 1 via network 3 and network interface 26 (S201: Yes), it stores the received printing job onto RAM 23 (S202).

Next, the header part of the received printing job is analyzed to see if it concerns with the default setup printing, i.e., if the command part of the printing job contains a default setup modifying command (S203). If the received printing job concerns with the default setup printing (S204: Yes), the command part is analyzed to obtain the default setup modifying command (S205) . In the meanwhile, printer 2 reads out onto RAM 23 a default setup table, which has the same contents as the one personal computer 1 has and which is stored in ROM 22 of printer 2, and updates the default setup of printer 2 stored in RAM 23 by modifying it to the default setup contents concerning the default setup modifying command obtained in step S205 (S206).

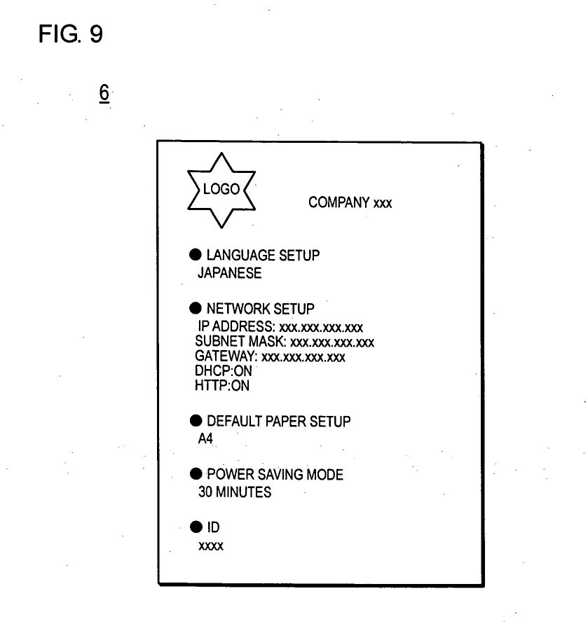

Next, the default setup contents updated in step S206 are converted into a text format, rasterized, and stored into RAM 23 (S207), and are printed as a status sheet (S208). FIG. 9 shows an example of status sheet printed with the contents of updated default setup to be printed by printer 2. As shown in FIG. 9, the contents of the default setup of printer 2 modified according to the default setup printing job received from personal computer 1 are printed on a status sheet 6. Accordingly, the user can check the contents of default setup of printer 2 modified according to the default setup printing job so that any setup errors during the default setup at the time of the shipment from the factory can be eliminated.

When printer 2 completes printing of the default setup contents (S208), it obtains the image data related to the test printing data by expanding the compressed image data part of the printing job, stores it into RAM 23 (S209), and prints out the image data related to the test printing data according to the default setup updated in step S206 (S210) thus completing the default setup printing process. Thus, the modified default setup becomes valid simultaneous with the default setup modifying process, so that the user can confirm whether the printing is made according to the modified contents of the default setup or whether the modified contents of the default setup are appropriate through actual prints.

The printing process for the default setup contents (S207 and S208) as well as the printing process for the image data part (S209 and S210) can be executed in any order.

On the other hand, if the received printing job in not related to the default setup print in step S204 (S204: No), printer 2 obtains the image data by expanding the image data part of the printing job according to the normal printing procedure (S209), and prints out the obtained image data (S210), thus completing the default setup printing process.

In the abovementioned embodiment, the setup items of the default setup table, the default setup modifying command, the contends of the default setup, and the like possessed by personal computer 1 can be arbitrarily modified by the user in advance. In this case, the contents of the default setup table possessed by personal computer 1 and printer 2 can be synchronized at a specific timing by means of a specific communication process. In the present invention, personal computer 1 does not necessarily have to have a default setup table and but rather can be constituted in such a way that the user directly specifies the default setup command (command constituting bits) in the default setup specifying process (S102) on personal computer 1.

Although it was specified in the above embodiment that personal computer 1 specifies an image data stored in its hard disk as the test printing data in the test printing data specifying process (S103), it is also possible to constitute in such a way that an image data stored in another device on network 3 is specified as the test printing data. In this case, it is constituted in such a way that the location information such as URL (Uniform Resource Locator) for said image data is entered in the same step, and the specified image data is downloaded from said another device through network 3 and network interface 17 in the printing job preparation process (S104).

Furthermore, although it was assumed in the above embodiment that the image data related to the test printing data is compressed and included in the printing job as it is into the printing job preparation process by personal computer 1 (S104), it can also be configured in such a way as to convert the image data into a page descriptive language to be included in the printing job. In this case, a process of analyzing the page descriptive language and rasterize the printing data instead of the expansion process of the image data (S209) in the default setup printing process of printer 2.

In the above embodiment, the program for controlling the operation of default setup printing job transmitting process of personal computer 1 is installed in personal computer 1 as dedicated application software, and is activated and executed at the time of default setup printing job transmitting process, but it can also be included in the printer driver software as a part of the printer driver software's function of printer 2 and be activated and executed as a part of the printing process of the image driver related to the test printing data.

Although the printing system according to the present invention was described in the above embodiment on the premise of conducting default setup and test printing in the inspection process at the time of the shipment of the printer from the factory, the mode of application of the printing system according to the present invention should not be construed to be limited to it. The present invention is useful, for example, for determining the default setup by confirming and adjusting printing results under a specific environment (e.g., for each type of paper) in the default setup for color printing condition and such when it is applied to color printing using an ink jet printer, etc.

Although a personal computer was assumed as the printing data transmitting device and a printer as the printing device in the abovementioned embodiment, the present invention should not be construed to be limited by them. In addition to a personal computer, a computer such as a work station or a server, a portable terminal such as a cellular telephone, PHS®, PDA, electronic pocket book, and the like, or a multifunctional peripheral device (MFP) with printing data transmitting capability can be used as a printing data transmitting device. Also, in addition to a printer, a MFP with printing capability such as a digital copying machine and a facsimile machine can be used as a printing device.

Each unit that constitute the printing job transmitting device and the printing device according to the present invention can be implemented either by a dedicated hardware circuit or by a programmed printing job transmitting device and a programmed printing device as described before. When implementing the present invention using such a programmed printing job transmitting device and a programmed printing device, the programs that cause the printing job transmitting device and the printing device to operate can be provided by computer-readable recording media such as Floppy® disks and CD-ROMs.

As mentioned above, according to the printing system of the present invention, it is possible to executed the default setup process and the test printing of the printing device simultaneously by means of transmitting a single printing job from the printing job transmitting device, so that the work efficiency of the default setup and test printing can be drastically improved.

Also, since the printing system according to the present invention makes it possible to execute the default setup operation for the printing device and the confirmation of the contents of the default setup after the operation simultaneously, it is possible to effectively prevent the occurrence of default setup errors due to mistakes in the setup operation.

What is claimed is:

1. A printing device comprising:
a printing job receiving unit for receiving a printing job;
a command analyzing unit for analyzing a command included in said printing job;
a default setup modifying unit for modifying a default setup based on a default setup modifying command when said command is said default setup modifying command; and
a printing unit for printing data to be printed included in said printing job.

2. A printing device claimed in claim 1, wherein said printing unit prints said data in accordance with the default setup modified by said default setup modifying unit.

3. A printing device claimed in claim 1, wherein
said printing unit prints the contents of the default setup modified by said default setup modifying unit.

4. A printing job transmission device comprising:
a default setup inputting unit for inputting a default setup for a printing device;
a printing job preparation unit for preparing a printing job including a default setup modifying command for modifying the default setup of said printing device to a default setup entered by said default setup input unit; and
a printing job transmission unit for transmitting said printing job to said printing device.

5. A printing system comprising a printing device and a printing job transmission device, which are connected to be able to communicate with each other; wherein,
said printing job transmission device comprising:
a default setup inputting unit for inputting a default setup for said printing device;
a printing job preparation unit for preparing a printing job including a default setup modifying command for modifying the default setup of said printing device to a default setup entered by said default setup input unit; and
a printing job transmission unit for transmitting said printing job to said printing device; and
said printing device comprising:
a printing job receiving unit for receiving a printing job;
a command analyzing unit for analyzing a command included in said printing job;
a default setup modifying unit for modifying a default setup based on a default setup modifying command when said command is said default setup modifying command; and
a printing unit for printing data to be printed included in said printing job.

6. A printing system claimed in claim 5, wherein said printing unit of said printing device prints said data in accordance with the default setup modified by said default setup modifying unit.

7. A printing system claimed in claim 5, wherein
said printing unit of said printing device prints the contents of the default setup modified by said default setup modifying unit.

8. A printing method comprising:
a printing job receiving step of receiving a printing job;
a command analyzing step of analyzing a command included in said printing job;
a default setup modifying step of modifying a default setup based on a default setup modifying command when said command is said default setup modifying command; and
a printing step of printing data to be printed included in said printing job.

9. A printing method claimed in claim 8, wherein said printing step prints said data in accordance with the default setup modified by said default setup modifying step.

10. A printing method claimed in claim 8, wherein
said printing step prints the contents of the default setup modified by said default setup modifying step.

11. A printing job transmission method comprising:
a default setup inputting step of inputting a default setup for a printing device;
a printing job preparation step of preparing a printing job including a default setup modifying command for modifying the default setup of said printing device to a default setup entered by said default setup input step; and
a printing job transmission step of transmitting said printing job to said printing device.

12. A printing program for causing a printing device to execute:
a printing job receiving step of receiving a printing job;
a command analyzing step of analyzing a command included in said printing job;
a default setup modifying step of modifying a default setup based on a default setup modifying command when said command is said default setup modifying command; and
a printing step of printing data to be printed included in said printing job.

13. A printing program claimed in claim 12, wherein
said printing step prints said data in accordance with the default setup modified by said default setup modifying step.

14. A printing program claimed in claim 12, wherein
said printing step prints the contents of the default setup modified by said default setup modifying step.

15. A computer-readable medium storing the printing program claimed in claim 12.

16. A printing job transmission program for causing a printing job transmission device to execute:
a default setup inputting step of inputting a default setup for a printing device;
a printing job preparation step of preparing a printing job including a default setup modifying command for modifying the default setup of said printing device to a default setup entered by said default setup input step; and
a printing job transmission step of transmitting said printing job to said printing device.

17. A computer-readable medium storing the printing job transmission program claimed in claim 16.
